(19) United States
(12) Patent Application Publication
(10) Pub. No.: US 2014/0128786 A1
(43) Pub. Date: May 8, 2014

(54) Massage Roller

(71) Applicant: Exemplar Design, LLC, Mason, OH (US)

(72) Inventor: Adam L. Ross, Mason, OH (US)

(73) Assignee: Exemplar Design, LLC, Mason, OH (US)

(21) Appl. No.: 14/069,807

(22) Filed: Nov. 1, 2013

Related U.S. Application Data
(60) Provisional application No. 61/721,879, filed on Nov. 2, 2012.

(51) Int. Cl. A61H 15/00

(52) U.S. Cl. CPC A61H 15/00
USPC 601/118

(57) ABSTRACT

A massage apparatus includes coaxially nested rollers, which may be frictionally engaged. Each roller includes a tubular frame, raised rolling bands, and a plurality of massaging protuberances, wherein the height of the bands is at least the height of the protuberances. The protuberances on each nested roller may be identical, but differ from the protuberances on each of the other rollers. Protuberances may be smaller on each successively nested roller. The bands and protuberances may be flexible and pliable, and made from rubber, silicone, neoprene or foam. The bands and protuberances may be formed directly in a sleeve covering the tubular frame. A removable cap may cover each end of the nested rollers.

### CROSS-REFERENCE TO RELATED APPLICATIONS

This application claims the benefit of U.S. Provisional Application No. 61/721,879 titled “Foam Roller,” filed Nov. 2, 2012, which is hereby incorporated by reference.

### BACKGROUND

The present disclosure generally pertains to fitness and massage therapy, and devices for relieving tightness, knots, and soreness from muscles in a user's body. Through use of a fitness and massage therapy roller, also referred to as a foam roller, a user may effectively and safely relieve muscle tension and pain.

### SUMMARY

Massage rollers and foam massage rollers for fitness and physical therapy, and massage devices, apparatuses, systems and methods are generally disclosed.

The apparatus of the present disclosure provides for a roller with massaging bumps to roll smoothly on the floor for massaging a user. The roller provides options of massaging bumps, or a solid massage area, and provides various configurations of bumps in the same massage system.

Some embodiments of massage rollers may include coaxially nested rollers. Some embodiments include frictionally nested rollers. Each nested roller may include a rigid cylindrical frame, referred to as a tube. The tube may have a circular cross section, or an oval or elliptical cross section.

Some embodiments of massage rollers include a plurality of massaging knobs, bumps, or protrusions, referred to as protuberances, distributed generally uniformly about the circumference of the roller. The massaging protuberances may be of various shapes, steepness, angles, and sizes. For example, protuberances may have a circular, ovular, rectangular or triangular base; protuberances may be semi-spherical, cubical, conical, or pyramidal; protuberances may have a round or flat top. In some embodiments, the massaging protuberances on each roller are identical, but differ from the protuberances on the other nested rollers in shape, size, density, or firmness. For example, the plurality of protuberances of each successively coaxially nested roller may be smaller than the plurality of protuberances of the larger roller it is nested in.

Some embodiments of massage rollers may further include one or more solid layers of smooth material around the tube, referred to as rolling bands. The height of the rolling band is at least the height of the massaging protuberances to ensure smooth and even motion of the roller when rolled on a flat surface. The band and protuberances may be made from rubber, foam, neoprene, or silicone.

Generally, the outer diameter of each nested tube is smaller than the inner diameter of the tube it is coaxially nested in. However, the outer diameter of a roller including the height of the bands, may be slightly larger than the inside diameter of the tube of the roller it is nested in to provide a friction fit.

An inner massaging roller may be selected by sliding the inner roller out from an outer roller. The rollers may be nested by sliding the inner massaging roller into the hollow tube of a larger, outer roller.

In exemplary embodiments, a rubber, foam, neoprene, or silicone sleeve may encase the entire tube, with the rolling bands and massaging protuberances formed directly in the sleeve.

In some embodiments, removable caps fit to the ends of the nested roller system; caps may include flanges on the inner or outer side of the cap.

### BRIEF DESCRIPTION OF THE DRAWINGS

The foregoing and other features of the present disclosure will become more fully apparent from the following description and appended claims of massaging apparatus, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a perspective view of an exemplary massage roller system;

FIG. 2 is a tubular frame of an exemplary massage roller system in three-quarter perspective;

FIG. 3 is an exemplary massage roller system in three-quarter perspective;

FIG. 4 shows an enlarged, partial front view of an exemplary roller;

FIG. 5 shows an exemplary massage roller system in a partially nested state;

FIG. 6 shows an exemplary massage roller system in an un-nested state;

FIG. 7 depicts various exemplary protuberance variations;

FIGS. 8A-8D show an alternate exemplary embodiment of the massage roller system; and

FIG. 9 shows an alternate exemplary embodiment of the massage roller system.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

Methods, systems, devices, and apparatus related to massaging rollers are described. Some example embodiments according to the present disclosure may pertain to foam rollers, rubber rollers, nested rollers, and apparatuses used in massotherapy.

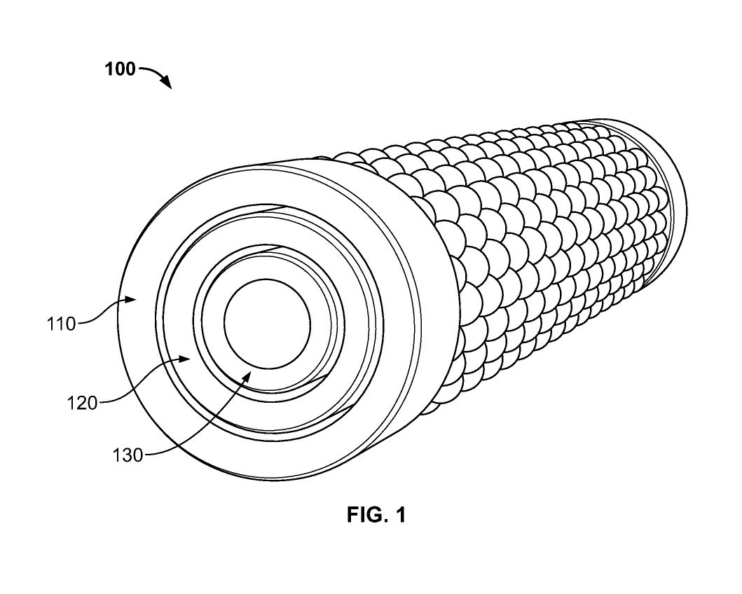

FIG. 1 shows a three-quarter front and end view of an exemplary roller system 100, having three coaxially nested rollers: outer roller 110, middle roller 120, and inner roller 130. Middle roller 120 and inner roller 130 are nested within the outer roller 110 and middle roller 120, respectively.

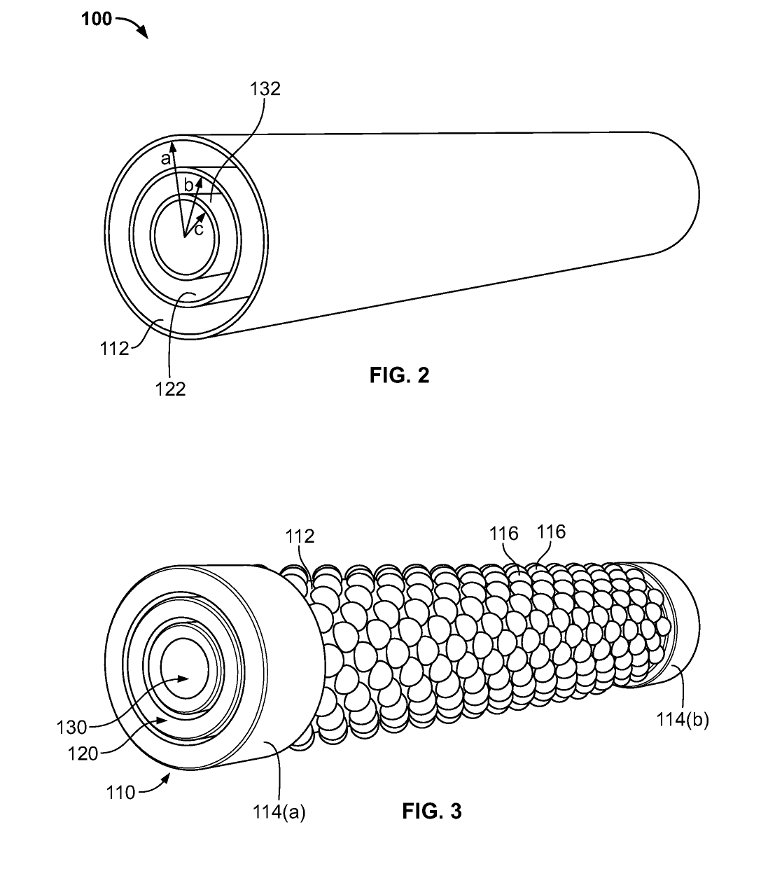

FIG. 2 shows only the cylindrical structure of an exemplary roller system 100. Tubes 112, 122, and 132 are coaxially nested, and provides the cylindrical shape for outer roller 110, middle roller 120, and inner roller 130, respectively. Each tube 112, 122, and 132 is generally congruent in length and shape, but vary in diameter to allow for nesting, with the innermost tube having the smallest diameter. As shown in FIG. 2, inner tube 132 has a diameter c, which is smaller than diameter b of middle tube 122, which is smaller than diameter a of outer tube 112. Tubes 112, 122, and 132 may be made from a rigid material, such as plastic, to provide structure to rollers.

FIG. 3 shows the exemplary roller system 100 from a three quarter side view. A solid layer of material forming rolling band 114 may encircle at least a portion of the outer surface of tube 112. In the exemplary embodiment shown in FIG. 3, a rolling band 114 wraps around each end of tube 112, forming proximal end band 114(a), and distal end band 114(b). Each band 114 (a) and (b) may abut the opposing edge of tube 112, with a width extending towards the opposite tube 112 edge. Band 114(a) and 114(b) may have a consistent thickness, and equal height to ensure roller 110 lies evenly to a flat surface. A plurality of massaging protuberances 116 may cover the surface of tube 112, and may be generally uniformly distributed circumferentially thereabout. Rolling band 114 and massaging protuberances 116 may be made from the same or different pliable or elastic material, such as rubber, foam, neoprene, or silicone. While the details of each roller has been explained in reference to outer roller 110, middle roller 120 and inner roller 130 may include similar or corresponding features of bands and protuberances (see FIG. 5).

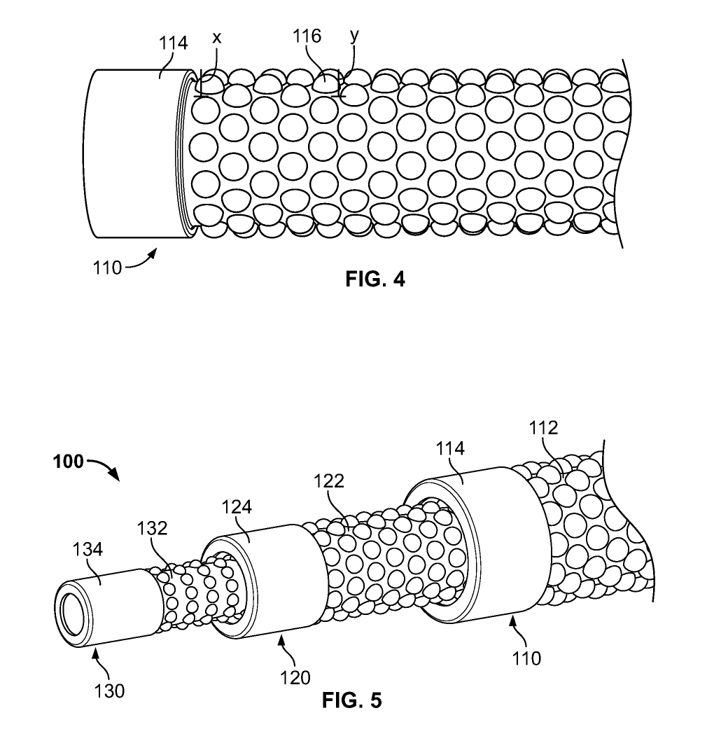

FIG. 4 shows a partial front view of roller 110. As shown in FIG. 4, the thickness, or height x of rolling bands 114 is at least height y of the massaging protuberances 116 to enable roller 110 to roll smoothly across a level surface. Thus, the maximum height y of protuberances 116 is dictated by height x of band 114 within roller 110, but the height x may vary between rollers 110, 120 and 130.

FIG. 5 shows exemplary roller system 100 in a partially nested state. Roller 120 may be frictionally engaged with roller 110. While the outer diameter of each tube is smaller than the inner diameter of the tube it is nested in, the diameter of the roller including the pliable rolling bands and massaging protuberances, may be slightly larger than the inner tube it is nested in to provide a friction fit. For example, middle tube 122 has an outer diameter b which is smaller than the inner diameter a of outer tube 112, but the diameter of middle roller 120 including height x of band 124 is equal to, or slightly greater than that of the inner diameter a of tube 112 of outer roller 110. The elasticity of band 124 and protuberances 126 may compress to fit, and expand slightly within, tube 112 to provide friction. Roller 130 may be similarly frictionally engaged with roller 120. To select inner roller 130 from the nested roller system 100, a user would apply enough pulling force to overcome the static friction between inner roller 130 and middle roller 120, sliding the inner roller 130 from middle roller 120. To replace inner roller 130, a user would apply pushing force sufficient to slide the inner roller 130 into the middle roller 120.

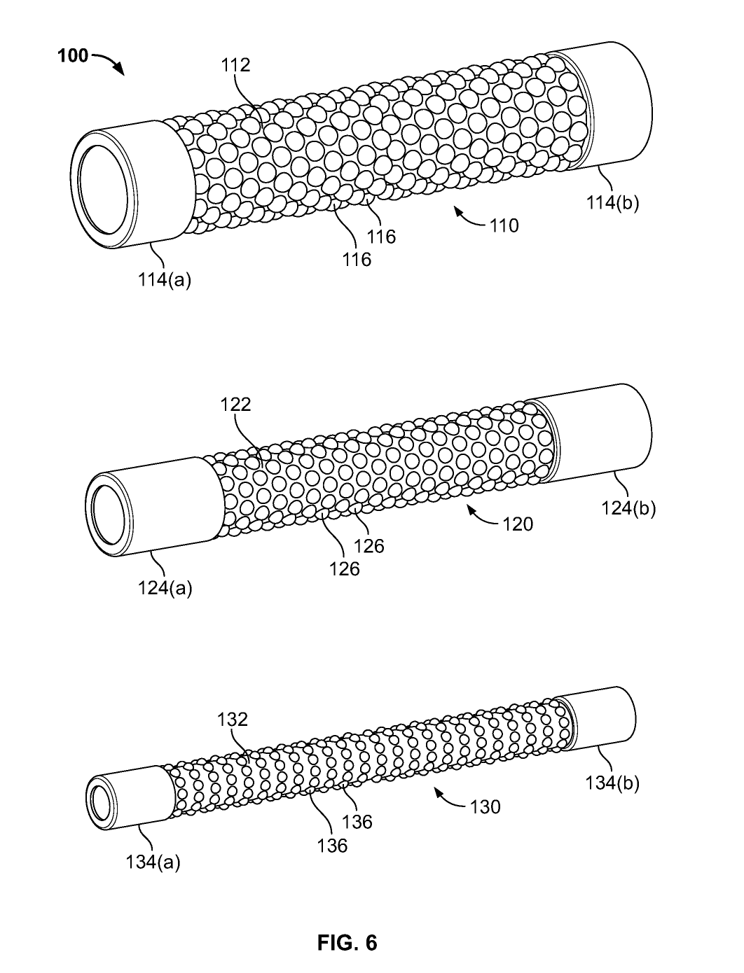

FIG. 6 shows an exemplary roller system 100 in an un-nested state. Massaging protuberances 116, 126, 136 on roller 110, 120 and 130 respectively may be of varying diameter, height, and density. The spacing between protuberances 116, 126, 136 may vary on each roller. In some embodiments, massaging protuberances on each successively nested roller are smaller than the protuberances on the larger roller. For example, protuberances 136 on roller 130 may have a lesser diameter and height than protuberances 126 of roller 120, or may be stiffer. Rolling bands 114, 124, 134 of each respective roller 110, 120, and 130 may also vary in height and width, or may be made from different materials having different hardness levels. As shown in FIG. 4, bands 124 on roller 120 may be wider than bands 114 on roller 110.

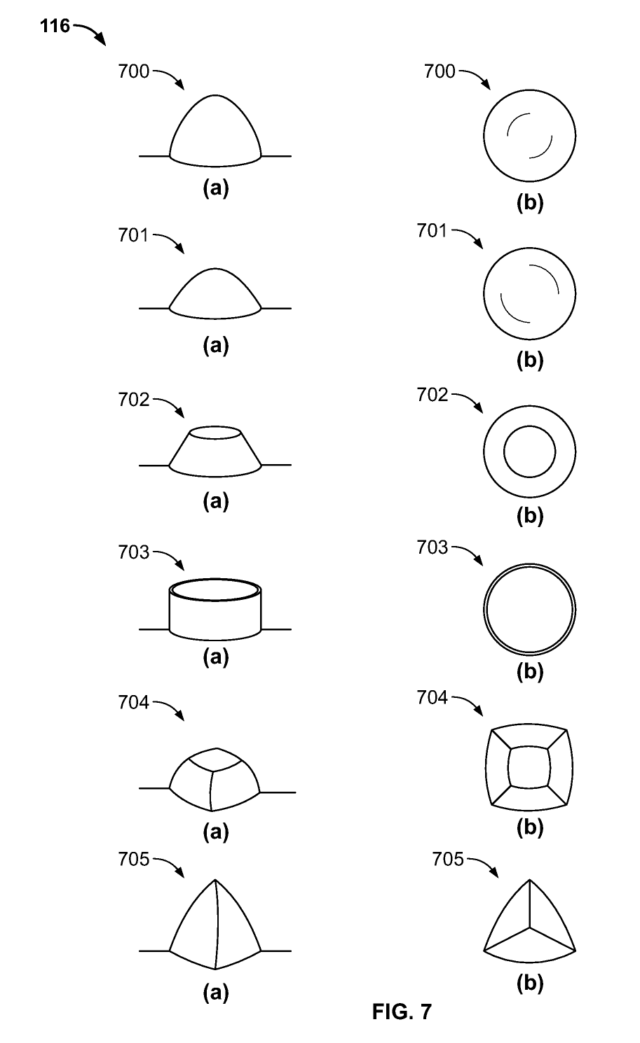

FIG. 7 depicts exemplary massaging protuberance 116 variations 700-705 both from a front view 700(a)-705(a), and a top view 700(b)-705(b). Protuberances 700-703 depict exemplary variations of protuberances with a round base. Protuberance 700 has a round base and a rounded projection, forming a semi-sphere. Protuberance 701 is also a semi-sphere, but has a shallower projection than that of protuberance 700. Protuberance 702 has a projection with a flat top. Protuberance 703 has a straight projection with a flat top, forming a cylinder. Protuberances 704-705 show variations in base shape; protuberance 704 has a square base, tapering projection, and a flat top, and protuberance 705 has a triangular base and pointed projection.

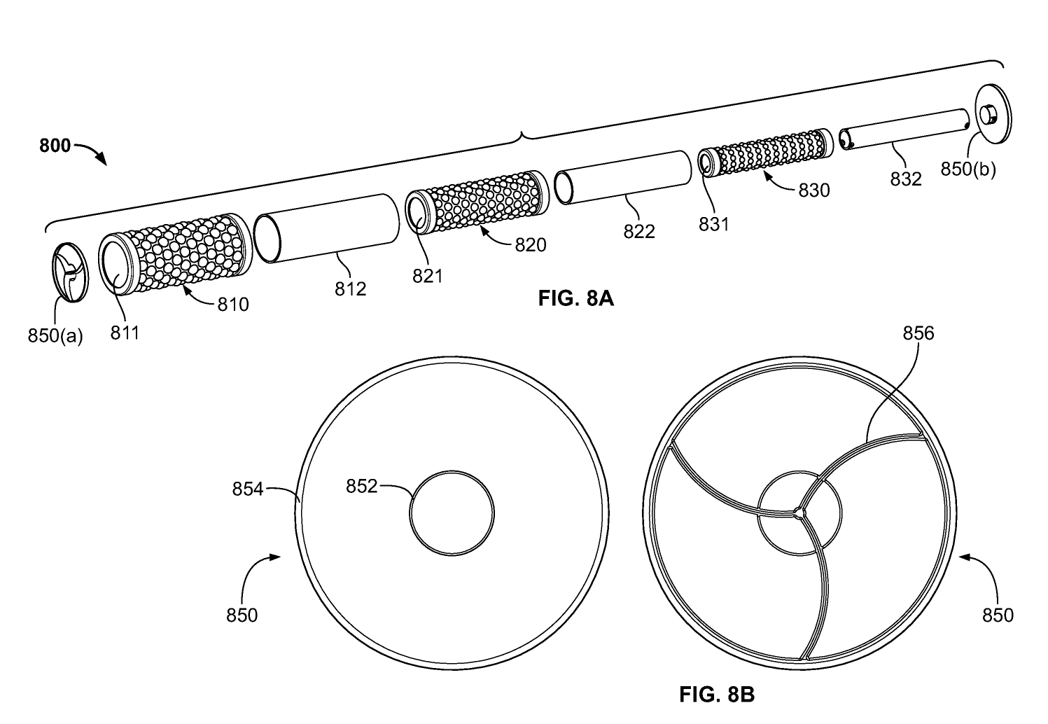

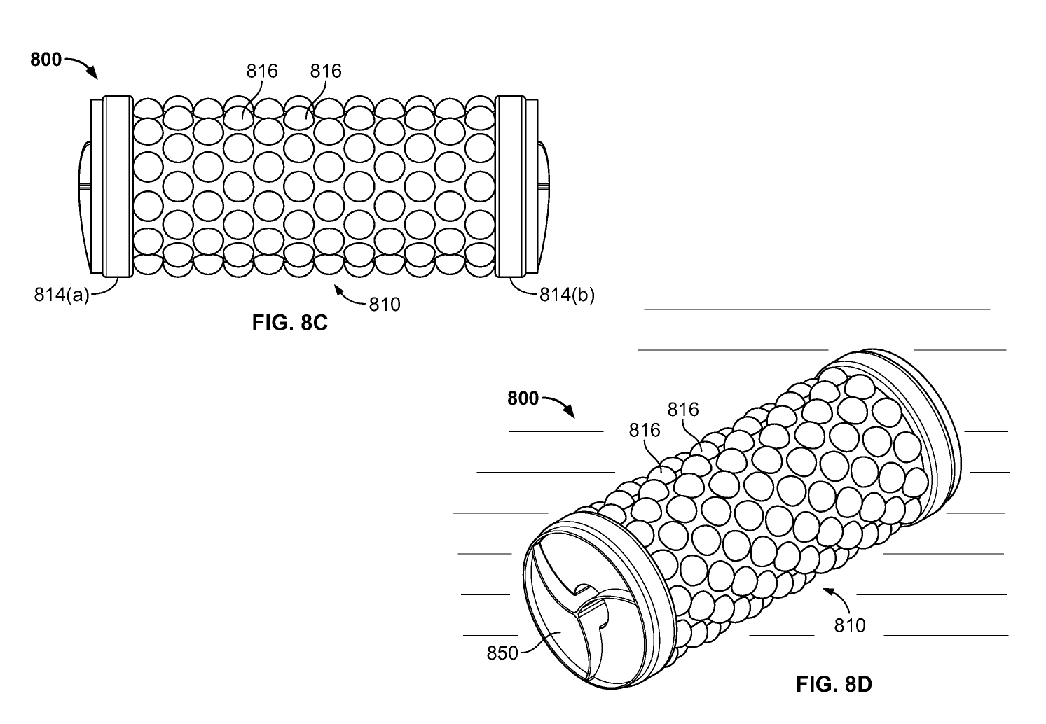

FIG. 8A shows an alternate exemplary embodiment of massage roller system 800 in an exploded view. Roller system 800 shows three nestable rollers: large roller 810, medium roller 820, and small roller 830, but may have fewer or additional rollers. In this embodiment, flexible sleeves 811, 821, 831 encase the rigid tubes 812, 822, 832 respectively. Referring to large roller 810 as an example, sleeve 811 may have pliable or flexible properties, and be made from foam, neoprene, silicone or rubber. The smooth raised rolling bands 814 and massaging protuberances 816 are formed in or molded directly from sleeve 811. Sleeve 811 may be stretched over tube 810 and secured with adhesive.

Massage roller system 800 may have removable caps 850(a) and 850(b) at each end of roller system 800, shown in FIG. 8A and FIG. 8B. As shown in FIG. 8B, cap 850 may have connection flanges 852 fitted to any of the plurality of rollers; flange 852 connects to inner roller 830, and flange 854 connects to outer roller 810. Cap 850 may include outer flanges 856 for easy handling of cap 850 for attaching and detaching from massage roller system 800. Cap 850 may keep the rollers nested, preventing the rollers from sliding apart.

Roller system 800 may be used by choosing the desired roller of the plurality of rollers. The desired roller 810, 820 or 830 may be selected based on the diameter, protuberances, smooth band portion, or other properties of the roller. Each roller 810, 820 and 830 may be used separately, or the smaller rollers may be nested within a larger roller being used. Cap 850 may be attached if the large roller 810 is selected, as shown in FIG. 8C. The selected roller 810 is placed on a flat surface as shown in 8D. The user places a part of the user's body on the roller, applying bodyweight to roll on the roller 800 in a back and forth or side to side motion.

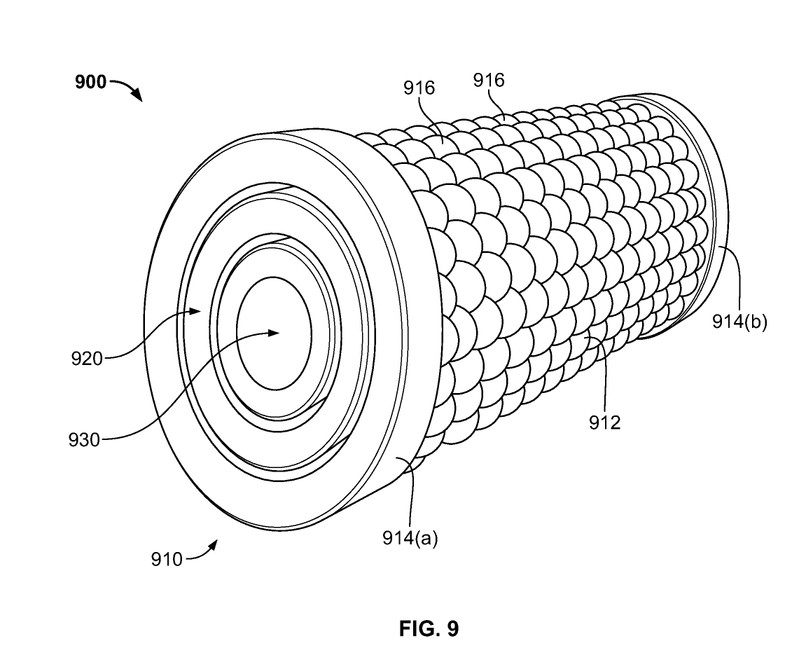

FIG. 9 shows an alternate exemplary embodiment of roller system 900 where tube 912 has an oval cross section. Nested rollers 910, 920, 930 each take on an oval shape. Roller system 900 includes band 914(a) and 914(b), and protuberances 916.

While example embodiments have been set forth above for the purpose of disclosure, modifications of the disclosed embodiments as well as other embodiments thereof may occur to those skilled in the art. Accordingly, it is to be understood that the disclosure is not limited to the above precise embodiments and that changes may be made without departing from the scope. Likewise, it is to be understood that it is not necessary to meet any or all of the stated advantages or objects disclosed herein to fall within the scope of the disclosure, since inherent and/or unforeseen advantages may exist even though they may not have been explicitly discussed herein.

What is claimed is:

1. A massage apparatus comprising:
a plurality of coaxially nested rollers, each roller including:
a tube;
a plurality of massaging protuberances extending radially from the tube, and distributed generally uniformly about a circumference of the tube;
a pair of bands, each encircling a respective segment of the tube, wherein the height of the bands are at least the height of the protuberances.

2. The massage apparatus of claim 1, wherein the plurality of coaxially nested rollers are frictionally engaged.

3. The massage apparatus of claim 2, wherein
the outer diameter of a first nested roller including the height of the bands is at least equal to the inner diameter of the tube of a second nested roller, wherein the first nested roller is nested in the second nested roller.

4. The massage apparatus of claim 1, wherein the plurality of coaxially nested rollers includes three coaxially nested rollers.

5. The massage apparatus of claim 1, wherein the tube of at least one of the plurality of coaxially nested rollers has one of: a circular cross section, and an elliptical cross section.

6. The massage apparatus of claim 1, wherein:
at least of one the plurality of protuberances of at least one of the plurality of coaxially nested rollers has a base which is one of: circular, ovular, rectangular, and triangular.

7. The massage apparatus of claim 1, wherein:
at least one of the plurality of protuberances of at least one of the plurality of nested rollers has a projection which is one of: flat-topped, tapered, pointed, semi-spherical, cubical, conical, and pyramidal.

8. The massage apparatus of claim 1, wherein:
the plurality of protuberances on a first one of the plurality of rollers are identical, and differ from the plurality of protuberances on a second one of the plurality of rollers in at least one of: shape, size, density, and firmness.

9. The massage apparatus of claim 8, wherein the plurality of protuberances of each successively nested roller is smaller than the plurality of protuberances of the roller it is nested in.

10. The massage apparatus of claim 1, wherein the pair of bands includes a band at each axial end of the tube.

11. The massage apparatus of claim 1, wherein the pair of bands and the plurality of protuberances have an equal radial height.

12. The massage apparatus of claim 1, wherein the pair of bands and the plurality of protuberances is made from one of: rubber, foam, silicone, and neoprene.

13. The massage apparatus of claim 1 further comprising a removable cap on each end of the plurality of coaxially nested rollers.

14. The massage apparatus of claim 13, wherein the cap comprises inner flanges for connection to at least one of the plurality of rollers.

15. The massage apparatus of claim 1, further comprising:
a plurality of sleeves encasing the tube of each of the plurality of rollers, wherein the plurality of protuberances and pair of bands are formed from the sleeves.

16. A method of using a massage apparatus comprising the steps of:
providing at least two coaxially nested massaging rollers, wherein each massaging roller comprises a pair of circumferential bands and a plurality of massaging bumps distributed relatively uniformly circumferentially thereabout, wherein the bands have a radial height equal to, or greater than the bumps;
separating an inner massaging roller from an outer massaging roller by sliding the inner massaging roller out from an outer massaging roller; and
replacing the inner massaging roller to the outer massaging roller by sliding the inner massaging roller into the outer massaging roller.

17. A massage apparatus comprising:
a plurality of frictionally engaged, coaxially nested rollers, each roller including:
a tubular structure;
a pliable sleeve encasing the tubular structure, wherein the sleeve comprises a smooth raised band at each opposing edge, and a plurality of identical massaging protuberances, wherein the height of the raised band is equal to, or greater than, the height of the plurality of protuberances;
wherein, the plurality of protuberances on each roller of the plurality of rollers differ from the plurality of protuberances on each of the other rollers of the plurality of rollers.

18. The massage apparatus of claim 17, wherein the plurality of protuberances of each successive roller is smaller than the plurality of protuberances of the roller it is nested in.

19. The massage apparatus of claim 17, wherein the sleeve is made from one of: rubber, silicone, neoprene and foam.

20. The massage apparatus of claim 17 further comprising a removable cap on each end of the plurality of nested rollers.
